(19) United States
(12) Patent Application Publication
(10) Pub. No.: US 2011/0168963 A1
(43) Pub. Date: Jul. 14, 2011

(54) TEMPORARY FENCE PANEL

(75) Inventor: Mark BOWMAN, Fewston (GB)

(73) Assignee: STEELHOARD LTD, Riccall (GB)

(21) Appl. No.: 13/006,775

(22) Filed: Jan. 14, 2011

Related U.S. Application Data
(63) Continuation of application No. PCT/GB2009/050857, filed on Jul. 15, 2009.

(30) Foreign Application Priority Data
Jul. 17, 2008 (GB) 0813130.2

(51) Int. Cl. E04H 17/16; B23P 11/00; B23K 31/02

(52) U.S. Cl. 256/24; 29/428; 228/101

(57) ABSTRACT

The present invention relates to a temporary fencing panel 10 comprising a frame 20 that defines an opening 29 and a mesh 30. The mesh 30 is located within the opening 29 of the frame 20 and is attached to the frame 20. This results in a panel that is safer to handle than conventional temporary fencing panels because there are no mesh ends that are loose or protrude from the frame on which a person may injure themselves.

### CROSS-REFERENCE TO RELATED APPLICATIONS

This application is a continuation of International PCT Patent Application No. PCT/GB2009/050857 filed Jul. 15, 2009, which claims the benefit of United Kingdom Application GB 0813130.2 filed on Jul. 17, 2008, which are incorporated herein by reference in their entireties for all purposes.

### FIELD OF THE INVENTION

The present invention relates to a temporary fence panel, in particular, a temporary mesh fencing panel.

Temporary fencing systems are widely used to cordon off areas temporarily. Temporary fencing systems comprise a number of fencing panels that are joined to one another to form a length of fencing. Fencing panels include wood panels, hoarding panels and mesh panels. One example of a mesh fencing panel is shown in FIG. 1. The panel 10 comprises a frame 20 and a mesh 30. The frame 20 is rectangular and comprises two vertical frame members 22, 24 welded to two horizontal frame members 26, 28. The mesh 30 comprises a plurality of vertical mesh members 32 and a plurality of horizontal mesh members 34 that are welded together at each intersection. The mesh 30 is welded to the front of the frame 20 by spot welding the edge of the mesh 30 to the horizontal members 22, 24 and the vertical members 26, 28.

Due to the manufacturing process of the mesh 30, the tolerance of the dimensions to which it is made may not be particularly good. In particular, sometimes the lengths of the vertical members 32 or horizontal members 34 of the mesh 30 may be longer, or shorter, than required. If any of the mesh members are too long then when the mesh 30 is welded to the face of the frame 20, ends 35 of the mesh may extend beyond the frame 20. Further, if any of the mesh members 32, 34 are too short then the ends 37 may not be properly welded to the face of the frame 20 and are hence are loose.

The above described faults may also occur if the mesh 30 is not positioned centrally on the frame 20. In other words, the ends of the mesh will extend beyond the frame on one side and the ends of the mesh will not be properly attached to the frame on the other side.

If there are protruding, or loose, mesh ends 35, 37, due to the mesh members extending beyond the frame 20 or not being properly secured to the frame 10, then this may present a hazard. For example, when a worker is handling such a ‘faulty’ fencing panel 10 the protruding, or loose, mesh ends 35, 37 may injure the worker's hand. The diameter of the mesh members 32, 34 is often of the order of 2-4 mm and therefore, in severe cases, the mesh ends 35, 37 may rip a tendon in the worker's hands. This risk can obviously be reduced by wearing gloves but even this may not be sufficient to prevent injury from occurring. Further, the protruding, or loose, mesh ends 35, 37 of a ‘faulty’ panel 10 may injure a member of the public who inadvertently comes into contact with the panel.

### SUMMARY OF INVENTION

It is therefore desirable to provide a fencing panel which reduces the risk of injury to a person coming into contact with the panel.

According to a first aspect of the invention there is provided a temporary fencing panel comprising: a frame that defines an opening; and a mesh; wherein the mesh is located within the opening of the frame and is attached to the frame. In one embodiment the frame comprises two vertical frame members and two horizontal frame members, connected together so as to form a substantially rectangular opening. The vertical frame members and a horizontal frame member may be formed from a continuous piece and the substantially rectangular opening may have at least one curved corner.

Preferably, the frame and mesh are planar and the plane of the mesh is located in between a plane defined by the front face of the frame and a plane defined by the rear face of the frame. Since the mesh is located within the opening of the frame, there are no loose or protruding ends of the mesh upon which a worker, or member of the public, can injure themselves.

The mesh may be directly attached to the frame. In one embodiment the mesh is welded to the frame. This allows the panel to be assembled at speed, and at low cost.

The mesh may comprise a plurality of vertical mesh members, including two end vertical mesh members, and a plurality of horizontal mesh members, including two end horizontal mesh members, the vertical mesh members crossing the horizontal mesh members at intersection points. The ends of the horizontal mesh members may be substantially flush with the end vertical mesh members. Further, each end vertical mesh member may be attached to one of the vertical frame members. In a preferred embodiment each end vertical mesh member is attached to a vertical frame member at mid-points between adjacent intersection points. This allows the end vertical member to curve outwards slightly, if necessary, so that it may better fit within the opening in the vertical frame member.

The ends of the vertical mesh members may be substantially flush with the end horizontal mesh members. Each end horizontal mesh member may be attached to one of the horizontal frame members.

According to a second aspect of the present invention there is provided a method of manufacturing a temporary fencing panel comprising the steps of: locating a mesh within an opening defined by a frame; and attaching the mesh to the frame.

The frame may comprise two vertical frame members and two horizontal frame members, connected together so as to form a substantially rectangular opening. The vertical frame members and a horizontal frame member may be formed from a continuous piece. The substantially rectangular opening may have at least one curved corner. Preferably the mesh is directly attached to the frame. In a particularly preferred arrangement the mesh is welded to the frame. The mesh may be fuse welded to the frame.

In one embodiment the frame is formed by locating frame members in a jig and welding the frame members together. In a preferred embodiment the mesh does not extend beyond the confines of the frame. The frame and mesh may be planar and the plane of the mesh may be located in between a plane defined by a front face of the frame and a plane defined by a rear face of the frame.

Preferably the mesh comprises a plurality of vertical mesh members, including two end vertical mesh members, and a plurality of horizontal mesh members, including two end horizontal mesh members, the vertical mesh members crossing the horizontal mesh members at intersection points. The ends of the horizontal mesh members may be substantially flush with the end vertical mesh members.

In a preferred arrangement each end vertical mesh member is attached to a vertical frame member. Each end vertical mesh member may be attached to a vertical frame member by gripping (or pinching) the two together and welding. Preferably each end vertical mesh member is attached to a vertical frame member at mid-points between adjacent intersection points, of the end vertical mesh member with the horizontal mesh members.

The ends of the vertical mesh members may be substantially flush with the end horizontal mesh members.

In a preferred arrangement each end horizontal mesh member is attached to the horizontal frame member. Each end horizontal mesh member may be attached to a horizontal frame member by gripping (or pinching) the two together and welding.

According to a further aspect of the present invention there is provided a method of manufacturing a temporary fencing panel comprising the steps of: locating two vertical frame members and two horizontal frame members in a jig; welding the frame members together to form a frame having a substantially rectangular opening; locating a mesh within the opening of the frame; and welding the mesh to the frame.

The invention may comprise any combination of the features and/or limitations referred to herein, except combinations of such features as are mutually exclusive.

### BRIEF DESCRIPTION OF DRAWINGS

Embodiments of the present invention will now be described, by way of example, with reference to the accompanying drawings, in which:

FIG. 1 schematically shows a prior art temporary fencing panel;

FIG. 2 schematically shows a front view of a temporary fencing panel according to a first embodiment of the present invention;

FIG. 3 schematically shows a portion of mesh welded to a frame;

FIG. 4 schematically shows sectional views along the lines A-A, B-B, C-C and D-D of FIG. 2;

FIG. 5 schematically shows sectional views along the lines E-E and F-F of FIG. 2;

FIG. 6 schematically shows a front view of a temporary fencing panel according to a second embodiment of the present invention;

FIG. 7 schematically shows a first method of manufacturing a panel according to an embodiment of the invention;

FIG. 8 schematically shows a second method of manufacturing a panel according to an embodiment of the invention; and

FIG. 9 schematically shows a welding gun for use in manufacturing a panel according to an embodiment of the invention.

### DESCRIPTION OF EMBODIMENTS

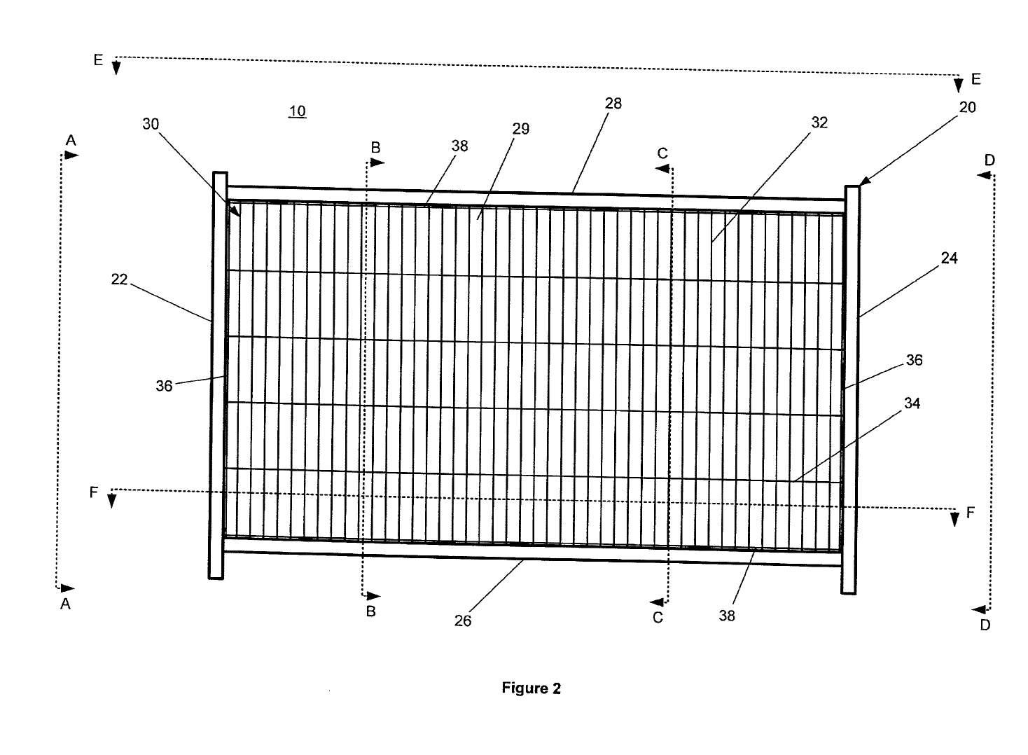

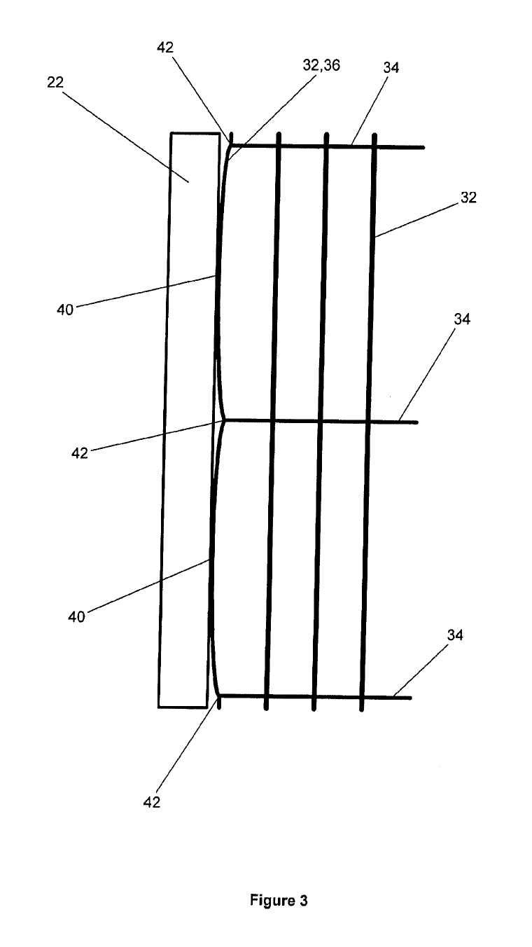

FIG. 2 shows a fencing panel 10 comprising a frame 20 and a mesh 30. The frame 20 comprises two substantially vertical frame members 22, 24 and two substantially horizontal frame members 26, 28. A first (or lower) horizontal frame member 26 is attached in between the vertical frame members 22, 24 towards their lower ends. A second (or upper) horizontal frame member 28 is attached in between the vertical frame members 22, 24 towards their upper ends. The frame 20 is substantially rectangular and the frame members define a substantially rectangular opening 29. The frame 20 is planar and lies in a first plane (in other words the axes of the frame members are all located in a single plane), the front face of the frame 20 (formed by the forward most points on the frame members) defines a second plane 21 (FIG. 3) and the rear face of the frame (formed by the rear most points on the frame members) defines a third plane 23 (FIG. 3. The first, second and third planes are substantially parallel.

The frame members 22, 24, 26, 28 are made from electro pre-galvanised tubular steel, preferably of circular cross-section, and are attached to each other by butt-welding. However, as will be readily apparent to one skilled in the art, other materials may be used for the frame members, they may have other suitable cross-sections and may be joined together by other suitable methods.

The mesh 30 is planar and comprises a plurality of vertical mesh members 32 and a plurality of horizontal mesh members 34 that are made from steel wire. The mesh members 32, 34 are approximately equally spaced in both the horizontal and vertical direction (though, as shown, the spacing of the vertical mesh members is somewhat less than that of the horizontal mesh members) and are spot welded together at each intersection. The vertical mesh members 32 have a diameter of approximately 2.5 mm and the horizontal mesh members 34 have a diameter of approximately 3.5 mm. The only exception to this is the end vertical mesh members 36 on each end of the mesh 30 which have a diameter of approximately 3.5 mm. Other dimensions may be suitable depending on the application. The mesh 30 is also made from electro pre-galvanised steel.

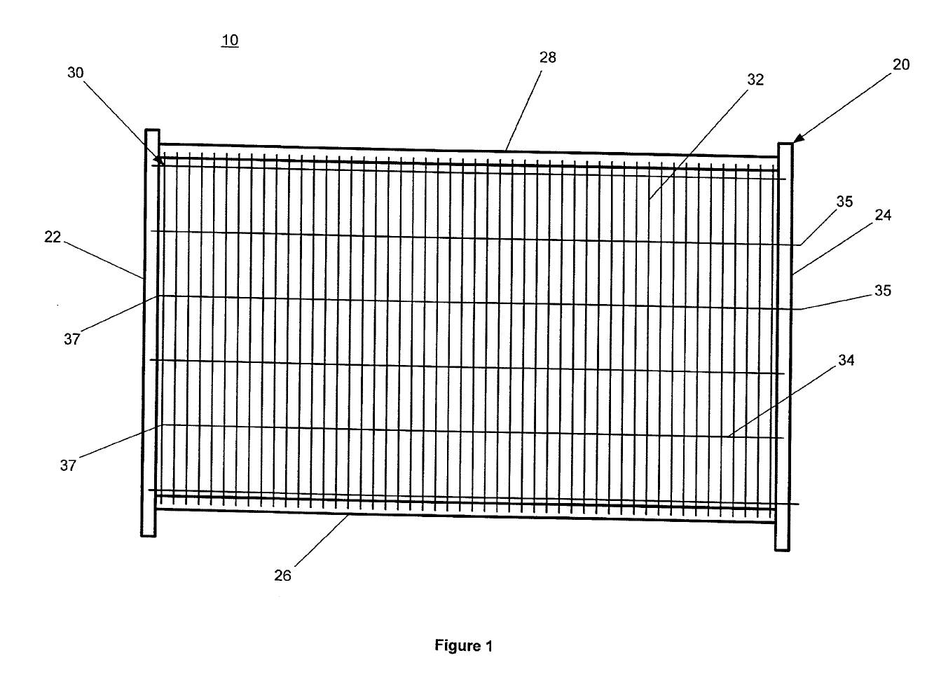

The overall size of the mesh 30 is slightly smaller than the size of the rectangular opening 29 of the frame 20. The ends of the horizontal mesh members 34 are flush with, or slightly protrude from (for example by a few millimetres), the end vertical mesh members 36. Similarly, the ends of the vertical mesh members 32 are flush with, or slightly protrude from, the end horizontal mesh members 38. This is different from the fencing panel mesh 30 of the prior art example shown in FIG. 1 in which the ends of the mesh members may protrude a significant distance (for example 50-100 mm) from the respective end mesh members.

The mesh 30 is located within the opening 29 of the frame 20. The plane defined by the mesh 30 is approximately coincident with the plane within which the frame 20 is located. In other words, the plane defined by the mesh 30 is located in between, and approximately parallel to, the planes that are defined by the front 21 and rear face 23 of the frame 20. The plane of the mesh may be approximately equidistant between the front and rear faces 21, 23 of the frame, or may be closer to one or other face. The important thing is that the whole of the mesh is located within the opening 29 such that it is surrounded by the frame members 22, 24, 26 and 28.

The mesh 30 is directly electro fuse welded to the frame 20. In this embodiment the mesh 30 is welded to the frame 20 at points on the inner sides of the frame members, facing the opening 29. Various welding techniques may be used such as spot welding, fuse welding, projection welding or MIG welding, for example. The end vertical mesh members 36 are welded at a number of positions to the vertical frame members 22, 24 and the end horizontal mesh members 38 are welded at a number of positions to the horizontal frame members 26, 28. Since the mesh 30 is slightly smaller than the opening 29 the mesh is pulled taught when it is attached to the frame members. This improves both the rigidity and appearance of the panel 10.

With reference to FIG. 3, in one embodiment the end vertical mesh member 36 is welded to the vertical frame member 22 at mid-points 40 between adjacent points 42 where a horizontal mesh member 32 intersects the end vertical mesh member 36. This means that if the overall width of the mesh 30 is slightly too small for the opening 29, the end vertical mesh member 36 can be caused to curve outwards slightly between each pair of intersection points, thus slightly increasing the width of the mesh 30, so that it can be more easily welded to the vertical frame member 22. Preferably the end vertical mesh member 36 is welded to the vertical frame member 22 at each mid-point 40 between adjacent intersection points 42. The end horizontal mesh members 38 may be connected to the horizontal frame members 28 in a similar manner except not every mid-point 40 need be welded.

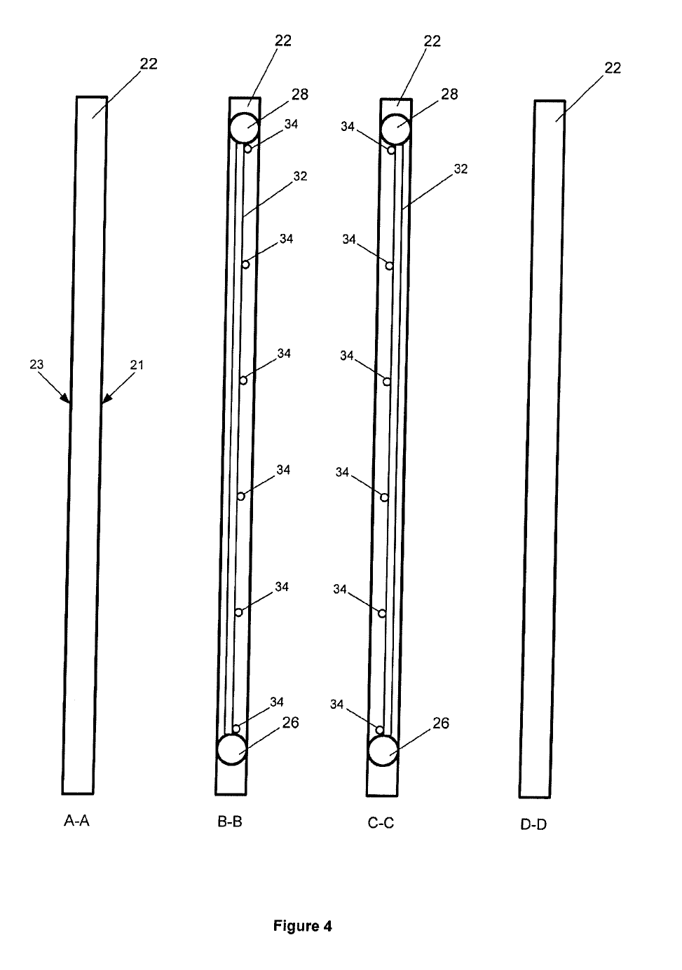

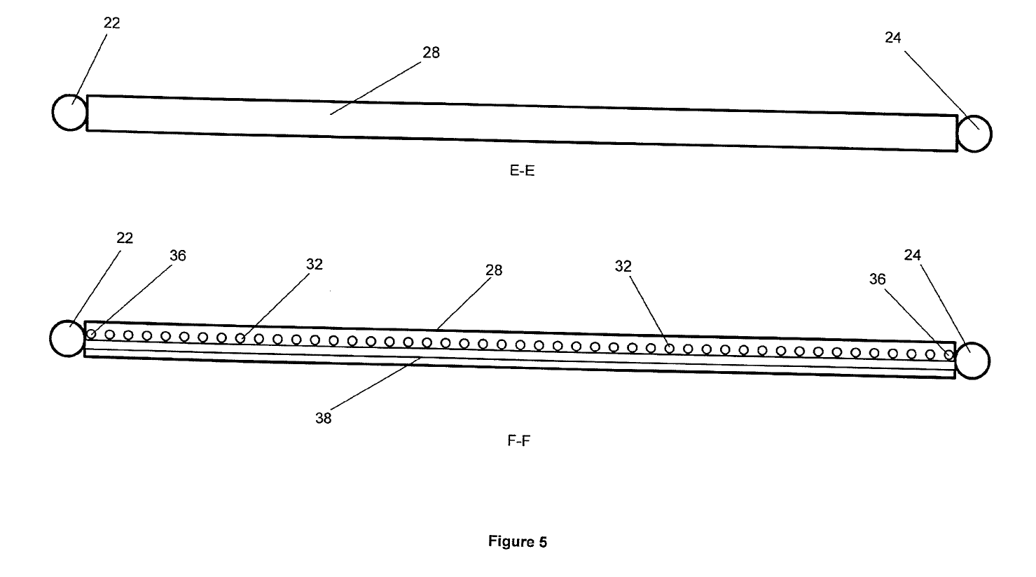

FIG. 4 shows the two end views A-A, D-D and the two sectional views B-B, C-C that are marked in FIG. 2. FIG. 5 shows the top view E-E and the sectional view F-F marked in FIG. 2. These figures clearly illustrate the mesh 30 located within the opening of the frame 20. Specifically, it can be seen that the mesh 30 does not extend beyond the confines of the frame 20, or more precisely the opening 29 surrounded by the frame members. This means that the fencing panel 10 is much safer to handle since there are no mesh ends that are loose or protrude from the frame 20 on which a person may injure themselves. Further, because the mesh 30 is located substantially equidistant between the front and rear faces 21, 23 of the frame (as opposed to on a frame face), the panel can be installed either way round.

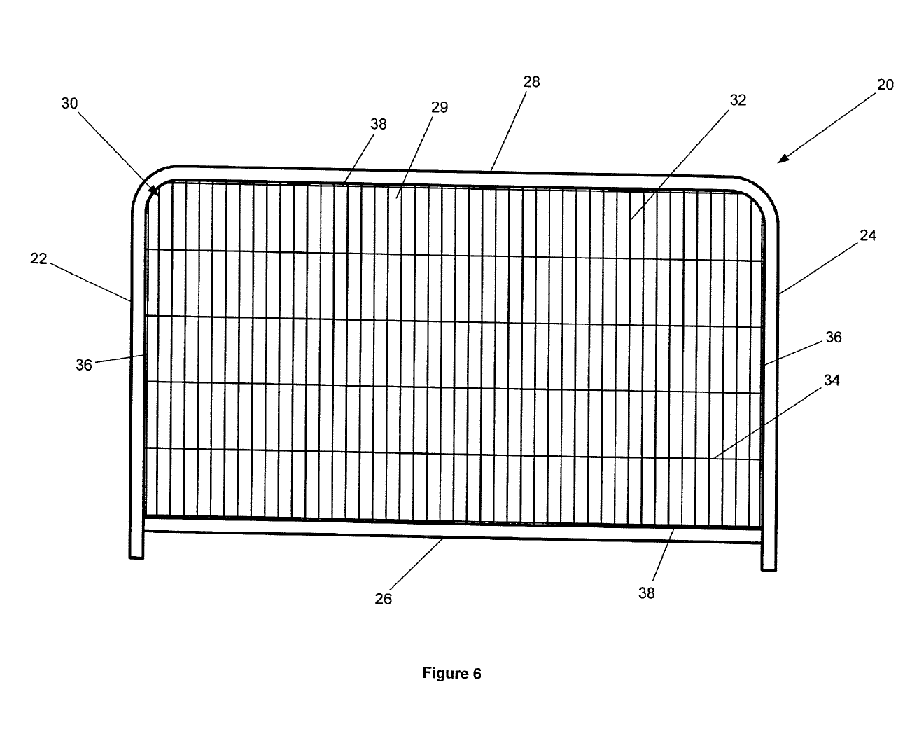

A second embodiment of a temporary fencing panel is shown in FIG. 6. The main difference between the first and second embodiments is that the frame 20 of the second embodiment comprises only two distinct frame members. The two vertical frame members 22, 24 and the top horizontal frame member 28 are formed from a single piece of bent tubular steel. The lower horizontal frame member 26 is attached in between the vertical frame members 22, 24 towards their lower ends. This defines an opening 29 that is rectangular with the upper two corners being curved. For the purposes of this description the opening can be considered to be substantially rectangular. The frame of the second embodiment is stronger and more rigid than that of the first embodiment due to the reduced number of distinct elements and welds.

As for the first embodiment, a mesh 30 is located within the opening 29 of the frame 20 and the plane defined by the mesh 30 is approximately coincident with the plane within which the frame 20 is located. The important thing is that the whole of the mesh is located within the opening 29 such that it is surrounded by the frame members 22, 24, 26 and 28. The upper corners of the mesh 30 may have to be slightly trimmed so that the mesh can be located within the opening. The mesh 30 is attached to the frame 20 in a similar way as in the first embodiment.

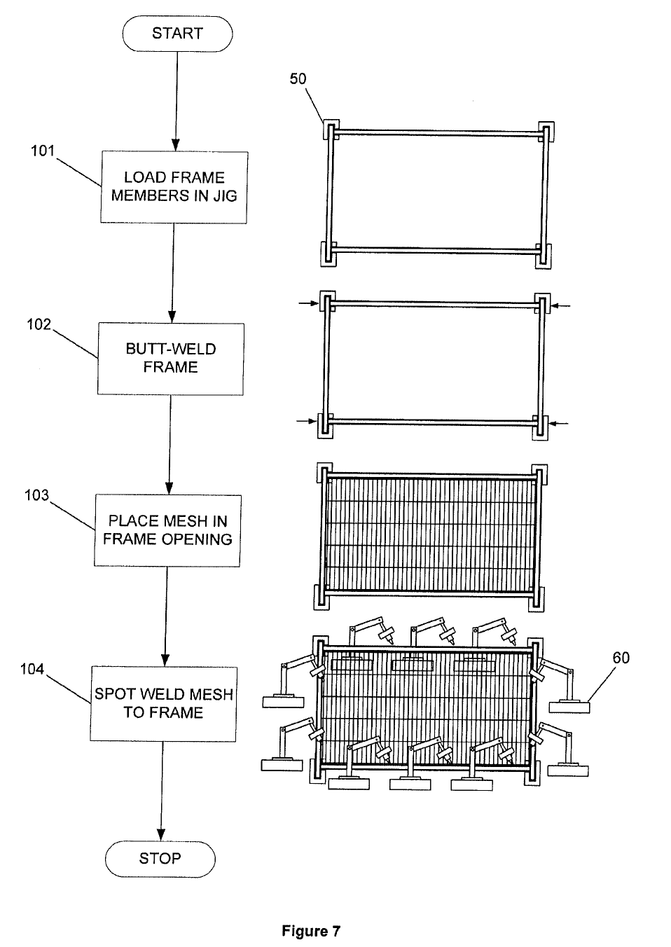

There are a number of methods of manufacturing the above described fencing panels 10. With reference to FIG. 7, in one method, the horizontal and vertical frame members 22, 24, 26, 28 are loaded into a jig by hoppers; Step 101. The joints between the horizontal and vertical frame members are then butt-welded together by passing a high current through the members whilst forcing them together; Step 102. This forms the frame 20. The mesh 30 is then placed into the opening 29 of the frame so that the plane of the mesh 30 is in between the plane defined by the front face of the frame 20 and the plane defined by the rear face of the frame 20; Step 103. The mesh 30 is then spot welded to the frame 20 using welding guns 60; Step 104. Specifically, the end vertical mesh members 36 are welded to the vertical frame members 22, 24 at a number of points and the end horizontal mesh members 38 are welded to the horizontal frame members 26, 28 at a number of points. As described above, the end vertical mesh members 36 may be welded to the vertical frame members 22, 24 at mid-points 40 between adjacent intersection points 42.

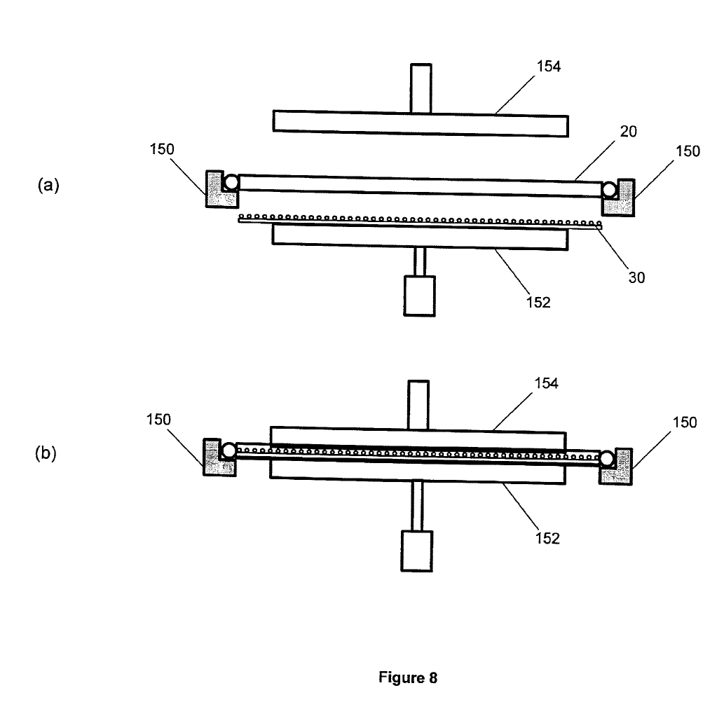

Referring now to FIG. 8, in a second method, the frame 20 and mesh 30 are pre-formed. The frame 20 is loaded into a jig 150 and the mesh 30 is placed into the opening 29 of the frame 20. The mesh 30 is supported in the opening 29 by a floating table 152 which can move up and down with respect to the frame 20 (FIG. 8a). The table 152 positions the mesh 30 such that its plane is approximately equidistant between the front and rear faces 21, 23 of the frame 20. In order to keep the mesh 30 flat (planar) it is pressed against the table 152 by a pressing member 154 (FIG. 8b). The mesh 30 is then welded to the frame 20 by welding the end vertical mesh members 36 to the vertical frame members 22, 24 at a number of points, and the end horizontal mesh members 38 to the horizontal frame members 38 at a number of points.

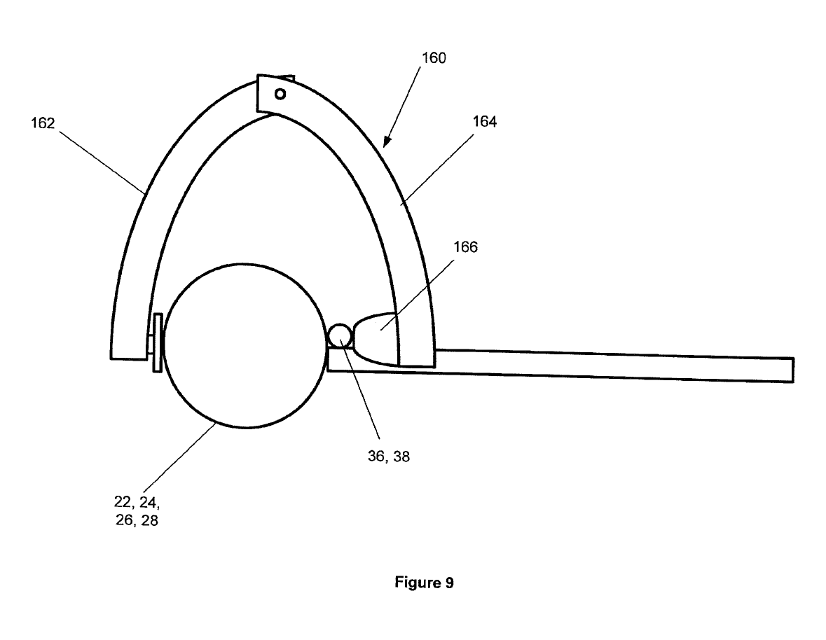

With reference to FIG. 9, the end mesh member (vertical or horizontal) 36, 38 is welded to the respective frame member 22, 24, 26, 28 by pinching (or gripping) the two together between two arms 162, 164 of a welding gun 160. The arm 164 in contact with the mesh member 36, 38 comprises the welding head 166. This method allows the mesh to be attached to the frame with ease.

1. A temporary fencing panel comprising:
a frame that defines an opening; and
a mesh;
wherein the mesh is located within the opening of the frame and is attached to the frame.

2. A temporary fencing panel according to claim 1, wherein the frame comprises two vertical frame members and two horizontal frame members, connected together so as to form a substantially rectangular opening.

3. A temporary fencing panel according to claim 2, wherein the vertical frame members and a horizontal frame member are formed from a continuous piece.

4. A temporary fencing panel according to claim 2, wherein the substantially rectangular opening has at least one curved corner.

5. A temporary fencing panel according to claim 1, wherein the mesh is directly attached to the frame.

6. A temporary fencing panel according to claim 1, wherein the mesh is welded to the frame.

7. A temporary fencing panel according to claim 1, wherein the mesh does not extend beyond the confines of the frame.

8. A temporary fencing panel according to claim 1, wherein the frame and mesh are planar and the plane of the mesh is located in between a plane defined by a front face of the frame and a plane defined by a rear face of the frame.

9. A temporary fencing panel according to claim 1, wherein the mesh comprises a plurality of vertical mesh members, including two end vertical mesh members, and a plurality of horizontal mesh members, including two end horizontal mesh members, the vertical mesh members crossing the horizontal mesh members at intersection points.

10. A temporary fencing panel according to claim 9, wherein the ends of the horizontal mesh members are substantially flush with the end vertical mesh members.

11. A temporary fencing panel according to claim 9, wherein each end vertical mesh member is attached to a vertical frame member.

12. A temporary fencing panel according to claim 11, wherein each end vertical mesh member is attached to a vertical frame member at mid-points between adjacent intersection points, of the end vertical mesh member with the horizontal mesh members.

13. A temporary fencing panel according to claim 9, wherein the ends of the vertical mesh members are substantially flush with the end horizontal mesh members.

14. A temporary fencing panel according to claim 9, wherein each end horizontal mesh member is attached to the horizontal frame member.

15. A method of manufacturing a temporary fencing panel comprising the steps of:
locating a mesh within an opening defined by a frame; and
attaching the mesh to the frame.

16. A method according to claim 15, wherein the frame comprises two vertical frame members and two horizontal frame members, connected together so as to form a substantially rectangular opening.

17. A method according to claim 16, wherein the vertical frame members and a horizontal frame member are formed from a continuous piece.

18. A method according to claim 16, wherein the substantially rectangular opening has at least one curved corner.

19. A method according to claim 15, wherein the mesh is directly attached to the frame.

20. A method according to claim 15, wherein the mesh is welded to the frame.

21. A method according to claim 20, wherein the mesh is fuse welded to the frame.

22. A method according to claim 15, wherein the frame is formed by locating frame members in a jig and welding the frame members together.

23. A method according to claim 15, wherein the mesh does not extend beyond the confines of the frame.

24. A method according to claim 15, wherein the frame and mesh are planar and the plane of the mesh is located in between a plane defined by a front face of the frame and a plane defined by a rear face of the frame.

25. A method according to claim 15, wherein the mesh comprises a plurality of vertical mesh members, including two end vertical mesh members, and a plurality of horizontal mesh members, including two end horizontal mesh members, the vertical mesh members crossing the horizontal mesh members at intersection points.

26. A method according to claim 25, wherein the ends of the horizontal mesh members are substantially flush with the end vertical mesh members.

27. A method according to claim 25, wherein each end vertical mesh member is attached to a vertical frame member.

28. A method according to claim 27, wherein each end vertical mesh member is attached to a vertical frame member by gripping the two together and welding.

29. A method according to claim 27, wherein each end vertical mesh member is attached to a vertical frame member at mid-points between adjacent intersection points, of the end vertical mesh member with the horizontal mesh members.

30. A method according to claim 25, wherein the ends of the vertical mesh members are substantially flush with the end horizontal mesh members.

31. A method according to claim 25, wherein each end horizontal mesh member is attached to the horizontal frame member.

32. A method according to claim 31, wherein each end horizontal mesh member is attached to a horizontal frame member by gripping the two together and welding.
